(19) United States
(12) Patent Application Publication
(10) Pub. No.: US 2003/0120618 A1
(43) Pub. Date: Jun. 26, 2003

(54) Method of ordering products using a printed publication

(76) Inventors: Larry Gregory Atil, Alta Loma, CA (US); Shari Daniels, Phillips Ranch, CA (US); Rachel Dunhoff, Temecula, CA (US); David Fruge, Irvine, CA (US); Claire Gordon, Oakland, CA (US); Dean Richard Lerch, Upland, CA (US); Henry Miersma, Chino, CA (US); Karin Miller, Long Beach, CA (US); Kristin Papoi, Montrose, CA (US); Kara Roberts, Murrieta, CA (US); Ron Seats, Corona, CA (US); Amy Elizabeth Smalley, Eagle, CO (US); Vanna Lee Lockwood, Corona, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 10/028,157

(22) Filed: Dec. 21, 2001

(51) Int. Cl. G06F 17/00

(52) U.S. Cl. 705/500

(57) ABSTRACT

Methods and articles of manufacture for an ordering system using a self-guided customer process are described. The ordering system is used by customers to select, measure, and order window treatments. The system utilizes a consistent ordering checklist that applies through all product categories, thus once a customer becomes familiar with ordering for one Product Category, such as Wood Blinds, ordering for another Product Category, such as Shades, is made easier because the process is consistent. The checklist for each Product Category corresponds to portions of the Order Form, making it easier for the customer to enter accurate information regarding product and design decisions into the Order form. The correspondence between the Product and Design selections is maintained by using numerals and letters (1(A,B,C, and D), 2, 3, and 4). A simplified measuring guide allows customers to take measurements for the appropriate products and enter the information in the Order Form.

### FIELD OF THE INVENTION

The present invention relates to methods and articles of manufacture for a customer-driven ordering process using ordering steps for the purchase of relatively complex products. In particular, it relates to a catalog ordering methodology for self-guided customer ordering of products, such as window shades, dressings, and related products which require product selection, design or option selections and measurements, and ways of making the ordering of such products less error-prone and more efficient for customers.

### BACKGROUND OF THE INVENTION

Purchasing window shades and various window treatments is not an easy task. There are numerous selections to make, materials, designs and finishes to choose from, deciding on cost and no-cost options, determining which options apply to which products, taking accurate measurements, determining how to use the measurements for the selected products, determining the price based on all the previous selections and measurements, and so on. It is a complicated task and errors in ordering occur frequently, even when the customer takes great care in the ordering process. Using a catalog instead of an actual salesperson makes the task even more challenging.

Nevertheless mail-order catalogs have been used for years for ordering products, such as window treatments. For example, various product manufacturers have been publishing and distributing mail-order catalogs for many years and customers have been ordering products from such catalogs. However, a significant percentage of orders placed through order forms have errors, missing information, or ambiguous ordering instructions; and frequently some customers become confused to the stage where they give up and do not complete the order form. The completed orders frequently require a call-back from an employee to the customer to clarify the instructions or to simply seek reassurance that what the customer did was correct. Obviously, call-backs are inefficient, costly, and delay the ordering and shipping process. Nevertheless, many customers prefer ordering through a catalog to save the time and expense of having to go to a store. Business for the window treatment retailer and customer satisfaction would both improve if the method or “system” for ordering window treatments from a catalog (mail-order, on-line, etc.) were more consistent across various product categories, less complex, and customer-friendly.

There were numerous problems or drawbacks with previous catalogs. Previously, for example, when selecting a particular product, customers were unlikely to read in detail the descriptions for each option. Customers were also not likely to notice elements such as option prices or descriptions if not placed prominently on the page. On order forms, customers become confused regarding the difference between an option and a product; for example, is an option written in the order form, should multiple options be written on the same line in the order form, and so on. By addressing these issues regarding options, the number of call backs or clarification calls can be reduced dramatically. Customers often do not complete columns in an order form dealing with terminology of which they do not have a complete understanding, for example, columns entitled “tilt.” Other problems arose from the practice of listing multiple options on one line which contradicts the expected catalog process of having one item per line. Another issue was the need to add all option prices and enter only the total per item.

### SUMMARY OF THE INVENTION

A catalog ordering system having consistent indicators, minimum clutter, and mechanisms for easily associating product design selections with completing an order form is described. The ordering system indicates which options should be written down on the order form. In one aspect of the present invention, a catalog-based product ordering method is described. A method of ordering a window treatment product using a catalog is described. The customer selects a product category. A product category has an introductory page clearly stating the name of the category and a checklist for the customer to follow to select and order the products in the category. The customer selects a design within the selected product category using the checklist. The checklist begins with “1 Choose” followed by four design selections: A Product Style, B Finish, C Upgrades, and D No Charge Options. The customer then refers to a measuring guide that can be used for any of the product categories. The measuring guide provides instructions for taking measurements for the selected product categories. The customer then completes an ordering form for the selected product category, the order form having a first section corresponding to the selected product category and selected design and a second section corresponding to measurements, and a third section corresponding to determining prices and order specifications. The first section is titled 1 Choose and has four sections corresponding to the checklist: A Product Style, B Material, Color Name and Number, C Upgrades, and D No Charge Options.

### BRIEF DESCRIPTION OF THE DRAWINGS

FIGS. 1A and 1B are flow diagrams of an overview of a process for ordering one or more window treatment products in accordance with one embodiment of the present invention.

FIG. 2 is a layout of a Product Category introductory page in accordance with one embodiment of the present invention.

FIG. 3 is a layout of a Product Style page.

FIG. 4 is a sample final page of the catalog ordering system.

FIG. 5 is a sample Order Form of the catalog ordering system.

FIG. 6 is a sample measuring guide page and sample boxes where a customer can note down measurements for each step of the catalog ordering system.

### DETAILED DESCRIPTION OF THE PREFERRED EMBODIMENTS

Methods and articles of manufacture, namely, a printed or online catalog or any type of printed publication intended for ordering window shades and window treatments utilizing a step-by-step customer guided process are described in the various figures. The methods described significantly reduce errors and confusion among customers using the catalog and order form. The methods and articles of manufacture described are not limited to printed publications for the sale of window treatment products but rather are applicable to any type of product purchased through a printed publication, such as a mail-order catalog.

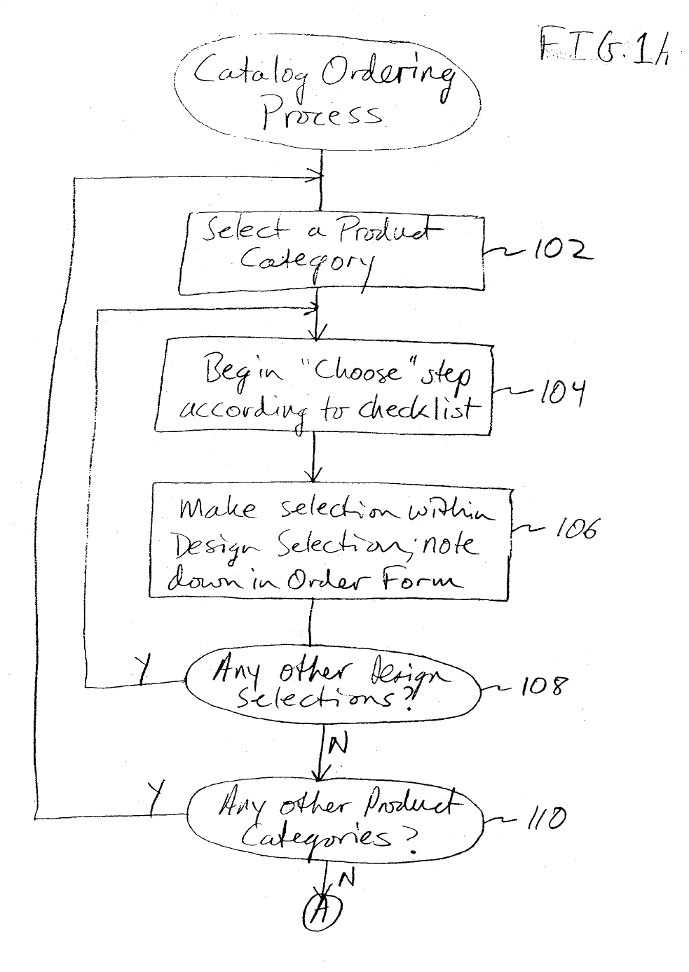

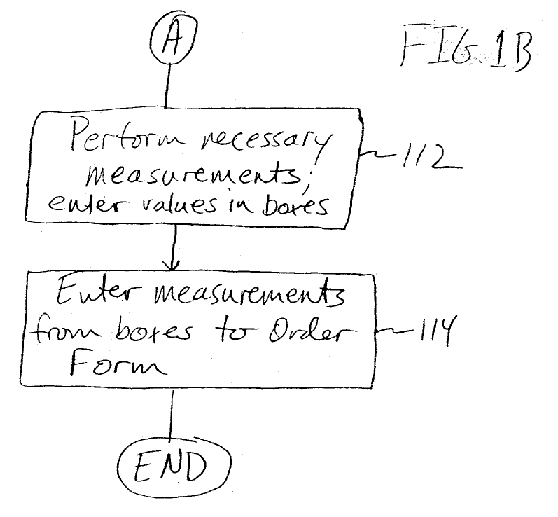

FIGS. 1A and 1B are flow diagrams of an overview of a process for ordering one or more window treatment products in accordance with one embodiment of the present invention. A customer uses a step-by-step ordering system to purchase a window treatment. In a preferred embodiment, the ordering system is in a catalog compiled by the window treatment seller or a merchant selling other products (“seller”) and sent to prospective and current customers through the mail. The catalog can also be picked up by customers in stores or be viewed and completed online. Customers can also perform the step-by-step ordering process at a terminal or kiosk at various locations, such as at the seller's store or at a public shopping area. In any of these cases, the process and system of the present invention are substantially the same.

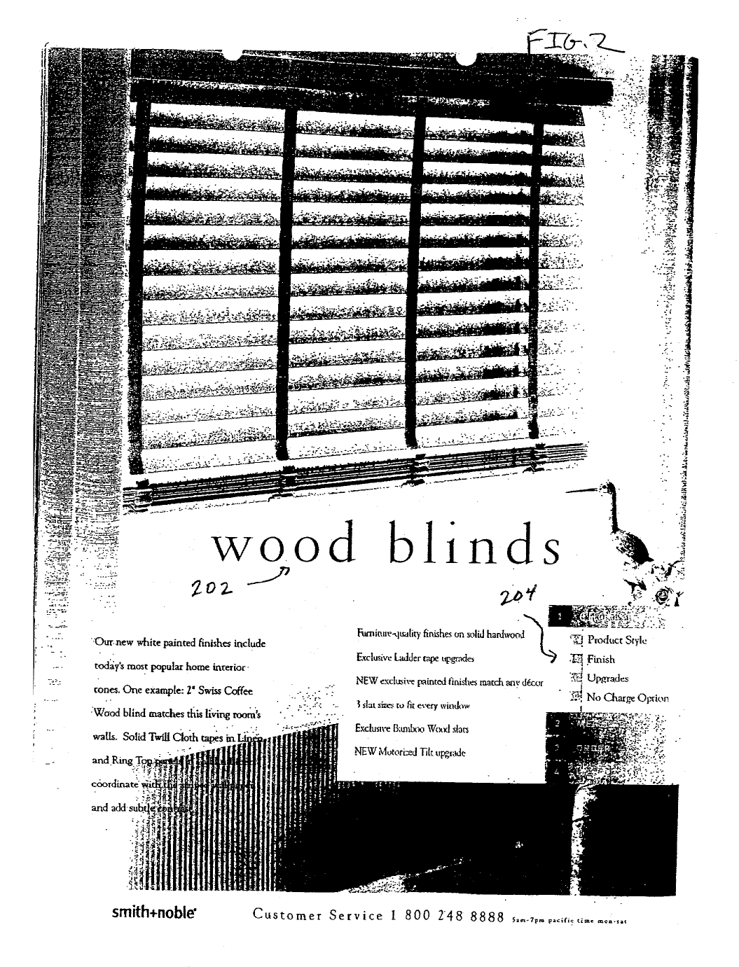

At step 102 the customer selects a Product Category, such as Wood Blinds, Roman Shades, Natural Romans, Roller Shades, Cornices, Draperies, Durawood Blinds, and Fabric Valances, among numerous others as determined by the seller. Each Product Category has an introductory page that clearly states the name of the Product Category, copy (text) regarding the product, such as benefits of the product, in a non-intrusive manner, and an overview of the steps, described below. FIG. 2 is a layout of a Product Category opening page in accordance with one embodiment of the present invention. The opening page contains a prominent product category label 202 and an ordering checklist shown in area 204. Once the customer has selected a Product Category, at step 104 the customer begins the “Choose” step by going to “Product Style”, the first Design Selection. For example, 2″ Wood Blinds is a Product Style in the Wood Blinds Product Category. In one embodiment, the type and number of Choose options will depend on the Product Category and is assigned a letter code (“A”, “B”, “C” etc.). In another preferred embodiment, the type of Choose options may differ but the number of options remains the same. In another preferred embodiment, the type and number of Choose options for the various Product Categories are the same. For example, for the Product Category, Wood Blinds, there is “A Product Style” “B Finish” “C Upgrades” and “D No Charge Options”. For the Roller Shades, there is “A Product Style” “B Material” “C Upgrades” and “D No Charge Options”. In another example for Natural Roman Shades, there is “A Product Style” “B Material” “C Upgrades” “D No Charge Options” and so on.

Each Product Category is introduced with a large or full-page photograph of one example of the product as shown in FIG. 2 and a headline, such as “Wood Blinds” or “Natural Roman Shades and Valances.” Below the headline is a listing of key benefits for wood blinds. The customer selects various design selections of the Product Category by going through the “Choose” step of the checklist. In the preferred embodiment, the Choose step is summarized on the first page after the Product Category is introduced as shown in FIG. 2. For example, for Wood Blinds, there is:

“1 CHOOSE

A Product Style

B Finish

C Upgrades

D No Charge Options”

In another example for Natural Roman Shades & Valances, there is:

“1 CHOOSE

A Product Style

B Material

C Upgrades

D No Charge Options”

As described above, in a preferred embodiment, the Choose step for each Product Category has the same number of steps, for example, A through D, although the function and name for a particular step may not be the same for all categories. In another embodiment, the Choose step may have additional or fewer steps by virtue of the nature of the product. For example, the Choose step for Honeycomb Shades may be:

“1 CHOOSE

A Product Style

B Fabric

C Color

D Upgrades

E No Charge Options”

In yet another example, the Choose step can have fewer steps, such as for Cornices:

“1 CHOOSE

A Product Style

B Finish

C Clearance depth (no upgrades or no-charge options available)”

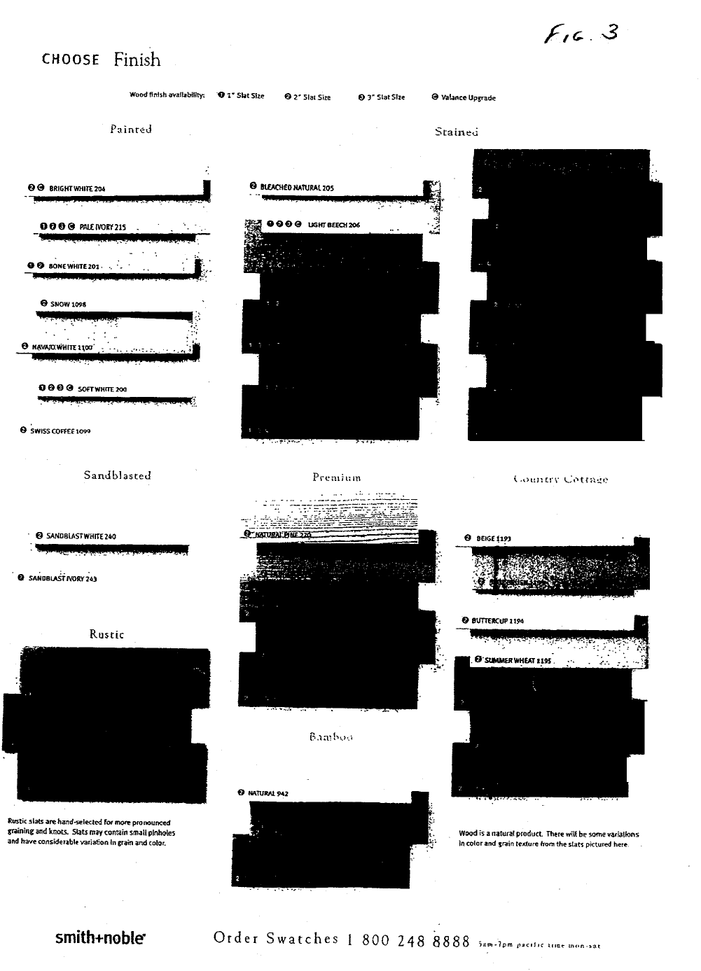

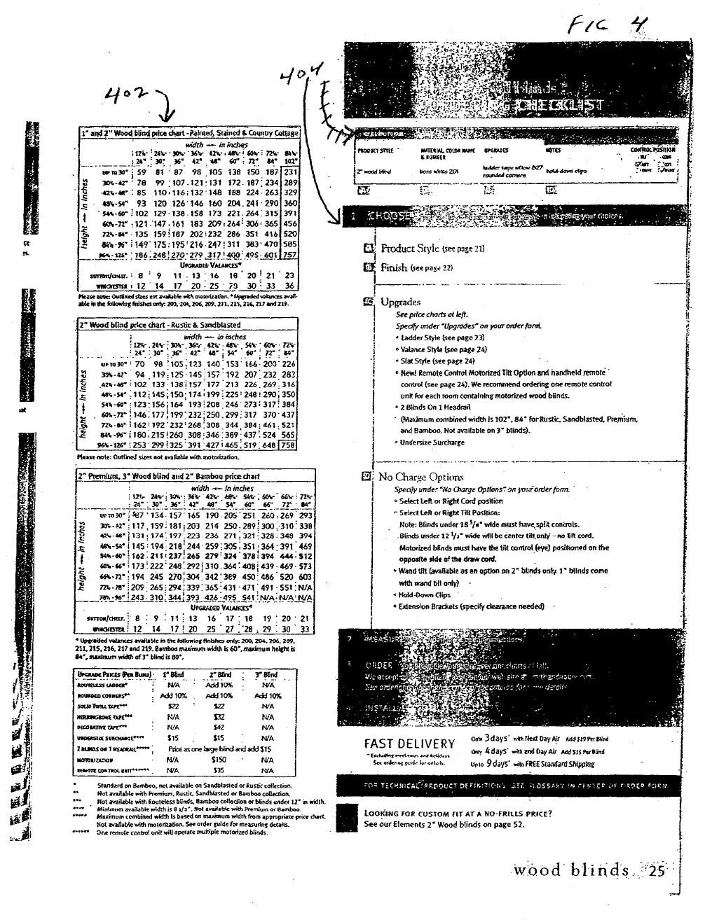

In a preferred embodiment, a Design Selection may be presented to a user on one page, such as in FIG. 3 showing selection “B CHOOSE Finish”. Each Design Selection page may have a different layout and design depending on the type of selection. However, not all Design Selections are presented graphically on a page. However, generally copy or text is kept to a minimum to keep the customer focused on the ordering process and for providing clear instructions for ordering. In a preferred embodiment, on the last page of each Product Category is a Price Chart and an Ordering Checklist. FIG. 4 is a sample ‘last’ page from the ordering system for Wood Blinds. It displays, on the left side, a Price Chart 402 comprised of a series of grids indicating prices and, on the right, an Ordering Checklist 404. For some of the Design Selections, the Ordering Checklist 404 lists a Design Selection for which a graphical or visual representation is not needed or a smaller scale visual will suffice. For example, with “C Upgrades” and “D No Charge Options”, the options are simply listed (e.g., “2 Blinds On 1 Headrail”, “Select left or right draw cord position” etc.). In some cases, references are made to page numbers within the same product category, typically one or two pages earlier. As will be seen throughout the ordering system, the customer does not need to flip through pages of the catalog or constantly go to different product areas of the catalog to obtain information regarding one Product Category. In a preferred embodiment the pages of the catalog relating to a Product Category including the measuring guide and order form are in close proximity of each other. In another preferred embodiment the pages of one Product Category are all consecutive.

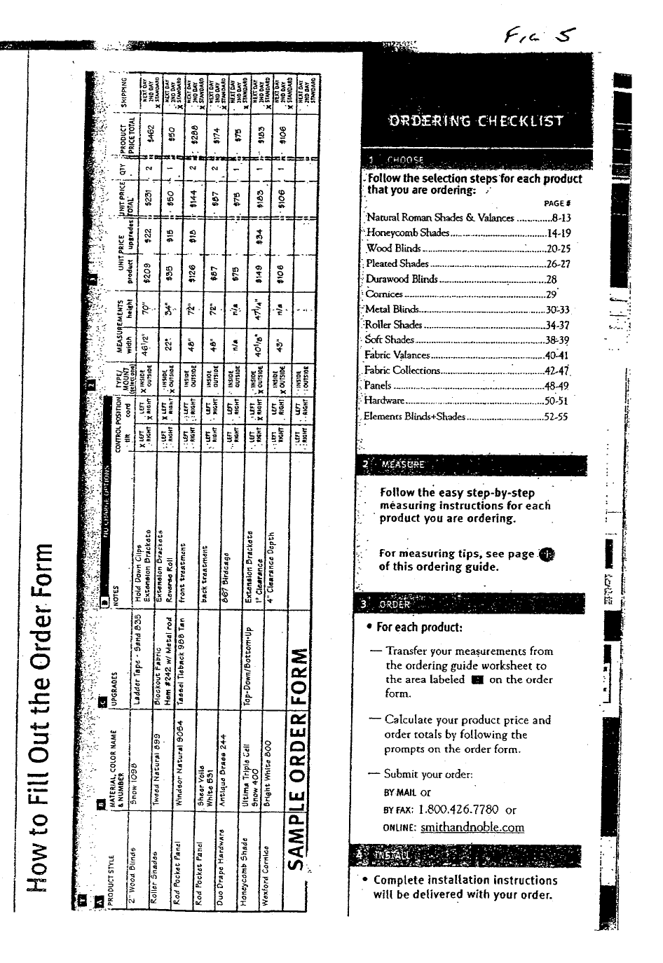

At step 106 the customer makes a selection within a Design Selection, such as 2″ blinds for A Product Style, Bone White 201 for B Wood Finish, Ladder Tape Willow 827 for C Upgrades, and Tilt: left, and Cord: right for D No Charge Options. As the customer makes these decisions, they are written down on the Order Form. FIG. 5 is a sample Order Form of the present invention. Product information is stored in a box 502 that corresponds to the Choose checklist. Product Style is entered in column A, Material, Color Name, and Number (e.g., Bone White 201) is entered in column B, Upgrades in column C, and No Charge Options in column D. Thus, there is consistency between the Order checklist and the Order Form, thereby making it easier for customers to record their selections and options in an orderly and unambiguous manner.

At step 108 the customer determines if there are any other Design Selections. If there are, control returns to step 104 and the customer selects the next Design Selection in the Choose checklist. If there are no more Design Selections in the Choose checklist, control goes to step 110 where the customer determines if there are any other Product Categories of interest to the customer. If there are, control returns to step 102 and the process is repeated. If the customer is done selecting products, at step 112 the customer performs the necessary measurements.

For measurements, the customer is referred to a section of the ordering system where the customer is instructed how to take accurate measurements for the one or more selected Product Categories. At step 2 of the Ordering Checklist on the last page of each Product Category the customer is directed to the “ordering guide” for measuring instructions. In a preferred embodiment, there is one measuring guide section for all Product Categories. The customer is directed to pages within the measuring and ordering guide for measuring instructions relevant to the general Product Category. In a preferred embodiment, the general Product Category breakdowns in the measuring guide section correspond to the specific Product Categories described above. For example, a customer can derive the general Product Category from the Product selection they have already made, e.g., “Wood Blinds” corresponds to the general category “Blinds” or “Natural Roman Shades” corresponds to the general category “Shades”. In another preferred embodiment, the Product Category in the measurement instructions have a one-to-one correspondence with the Product Selection made earlier.

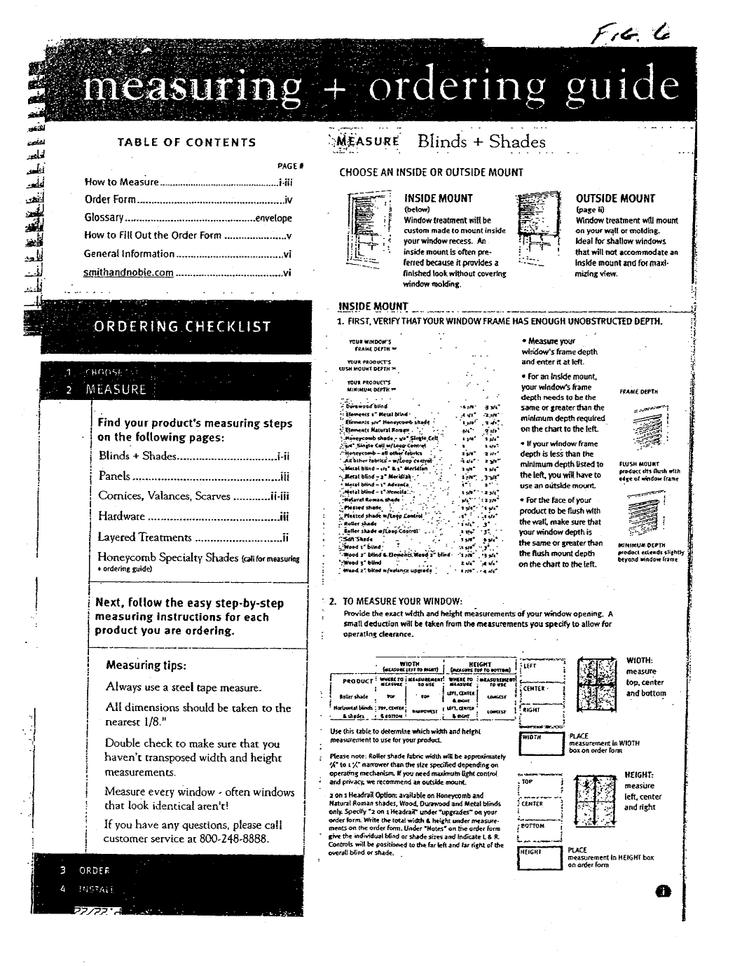

The customer checks dimensions and space and takes actual measurements according to the instructions provided in the measuring guide. There are boxes provided where the customer can enter measurements for each step. An example of this is shown in FIG. 6. Boxes 602 and 604, having bold borders, are used to store measurements that will ultimately be used in the “2 MEASURE” section of the Ordering Form. Next to boxes 602 and 604 are instructions to write the measurement value in the particular box on the Order Form. Some of the values are derived from charts and tables in the guide based on measurements. At the beginning of the measuring guide are measuring tips for the customer.

At step 114 the customer enters the measurements from the bolded boxes in the measuring guide to the Order Form in the area “2 Measure”. This is done for each product style selected. In another embodiment, the customer can take measurements for each of the product styles and fill in the Order Form before selecting the next Product Style, in which case the customer may be flipping through pages of the catalog with more frequency than if the customer selects or chooses all the Product Categories, Product Styles, and so on first and then performs the measurements and enters the Order information in step 112. The “3 ORDER” section guides the customer through determining the total price for the product and the type of shipping desired. Once the Order information has been entered, the customer has completed the ordering process. The remaining portions of the Order Form are completed and sent to the seller. Once the customer receives the products, the products are typically installed by the customer.

The Ordering System of the present invention provides consistency of steps regardless of which Product Category the customer selects at step 102. In a preferred embodiment, the customer is presented with the same checklist on the first page of the Product Category regardless of the specific Product Category. As described above, the Ordering System also has a checklist having the following steps: 1 Choose (A Product Style B [Material, Color Name & Number {varies by product}] C Upgrades D No Charge Options); 2 Measure; 3 Order; and 4 Install. The customer grows accustomed to following these steps for each Product Category. In addition to the consistency of the checklist, there is consistency within the Choose step, namely, steps A through D. Within the Choose checklist, “C Upgrades” and “D No Charge Options” may not be applicable and is indicated as so or is not included in the Choose sub-checklist. In previous ordering systems, the Choose checklist was not consistent and did not use numerical and alphabetical step indicators. Previous checklists had many steps that were specific to a Product Category. For example, the Natural Romans Product Category may have had the following Design Selections in the Choose checklist: Select shade or valance style, Select material, Select edge binding, Select valance style, Select privacy liner and so on. The Wood Blinds Product Category may have had the following Choose checklist: Select style, Select finish/color, Select ladder-type, Select valance style, Specify options, and so on. In one embodiment of the present invention, the Choose checklist for all Product Categories are consistent and have steps A through D.

The ordering system of the present invention also provides the customer with an Ordering Checklist. An example is shown in FIG. 4 for the Wood Blinds Product Category. The checklist has the same format as the checklist on the first page of the Product Category but is expanded. At the top of the Checklist is an example of a selections made for Product Style, Material, Color Name & Number, Upgrades, and No Charge Options. Under each selection is a letter A, B, C, and D corresponding to sections on the Order Form where information is entered by the customer. By having a detailed Ordering Checklist on one page, which takes the customer through the product decisions step-by-step the customer does not have to flip back and forth across pages to identify what selections are required. In sum, the 1 (A,B,C, and D), 2, 3, and 4 (Install) format of the Ordering System is used for ordering any type of product. This consistency is particularly helpful in taking product and design selections made by the customer and transferring the information to the Order Form in a manner that greatly reduces errors and ambiguity.

What is claimed is:

1. A printed publication containing product descriptions for selecting and ordering products, the printed publication comprising:
a product category page providing an overview of a plurality of steps, wherein a step has a corresponding indicator;
at least one page after the product category page providing selections within a product category, wherein a selection has a corresponding indicator;
an order form in which information regarding product selections is entered, the order form having one or more sections that correspond to the plurality of steps, thereby facilitating the product ordering process; and
a measuring guide that provides a measuring process for a product category such that measurements taken are easily transferred to the order form.

2. A printed publication as recited in claim 1 wherein the printed publication is a mail-order catalog intended for selling window treatment products.

3. A printed publication as recited in claim 1 wherein the plurality of steps has a fixed format for two or more product categories.

4. A printed publication as recited in claim 1 wherein the plurality of steps has a similar appearance for two or more product categories.

5. A printed publication as recited in claim 1 further comprising an ordering system checklist.

6. A printed publication as recited in claim 5 wherein the ordering system checklist includes a design selection choice, a measure choice, and an order choice.

7. A printed publication as recited in claim 1 wherein pages within the printed publication corresponding to a particular product category, the order form, and the measuring guide are in close proximity of each other.

8. A method of purchasing a product using a printed publication, the method comprising:
selecting a product category;
selecting an item within the selected first product category;
referring to a measuring guide applicable to a plurality of product categories including the selected product category; and
completing an order form for the selected product category, the order form including a first section corresponding to the selected product category and selected first item and a second section corresponding to measurements.

9. A method as recited in claim 8 wherein the item is a design selection relating to the product category.

10. A method as recited in claim 8 further comprising referring to measuring instructions for the selected product category.

11. A method as recited in claim 8 further comprising selecting a second product category wherein the steps of selecting a first item, referring to a measuring guide, and completing an order form for the product category are the same as for the second product category.
